(19) United States
(12) Patent Application Publication
(10) Pub. No.: US 2003/0161582 A1
(43) Pub. Date: Aug. 28, 2003

(54) Grating device, light source unit, and optical system

(75) Inventor: Masayuki Shigematsu, Yokohama-shi (JP)

Correspondence Address: MCDERMOTT WILL & EMERY, 600 13TH STREET, N.W., WASHINGTON, DC, 20005-3096, US

(73) Assignee: Sumitomo Electric Industries, Ltd.

(21) Appl. No.: 10/372,968

(22) Filed: Feb. 26, 2003

(30) Foreign Application Priority Data
Feb. 26, 2002 (JP) P2002-050112

(51) Int. Cl. G02B 6/34

(52) U.S. Cl. 385/37; 385/11

(57) ABSTRACT

The present invention relates to a grating device and the like which can lower the degree of polarization of light, while having a structure which can be obtained inexpensively in a small size. The grating device comprises a polarization-maintaining optical fiber, and a long-period grating formed in at least a core region of the polarization-maintaining optical fiber. The grating period of the long-period grating, its effective refractive index with respect to a first mode light component, its effective refractive index with respect to a second mode light component, and respective wavelengths of the first and second mode light components satisfy a phase matching conditional expression.

### BACKGROUND OF THE INVENTION

1. Field of the Invention

The present invention relates to a grating device which lowers the degree of polarization of incident light, a light source unit including the grating device, and an optical system including the light source unit.

2. Related Background Art

In a system which Raman-amplifies signal light propagating through an optical fiber, Raman amplification gain varies depending on the respective states of polarization of Raman amplification pumping light and signal light propagating through the optical fiber. Namely, the Raman amplification gain becomes greater when the pumping light and signal light have the same polarization direction, and smaller when their polarization directions are orthogonal to each other. If at least one of the polarization directions of pumping light and signal light fluctuates with time, the Raman amplification gain will also fluctuate with time in synchronization with the temporal fluctuation in the polarization direction. Such polarization dependence of Raman amplification gain can be reduced if the pumping light supplied to the optical fiber is depolarized.

For example, a literature—Y. Emori, et al., 100 nm bandwidth flat gain Raman amplifiers pumped and gain-equalized by 12-wavelength-channel WDM high power laser diode”, OFC '99, PD19 (1999)—discloses a technique in which two linearly polarized light beams outputted from respective semiconductor laser light sources are polarization-combined by a polarization beam combiner, and thus depolarized light is utilized as pumping light for Raman amplification.

On the other hand, Japanese Patent Application Laid-Open No. 2001-147454 discloses a technique in which two polarization-maintaining optical fibers are connected to each other while their primary optic axes differ from each other, such that light outputted from a semiconductor laser light source propagates through one polarization-maintaining optical fiber and then the other, so as to be depolarized, and thus depolarized light is utilized as Raman amplification pumping light.

### SUMMARY OF THE INVENTION

The inventor studied the prior art mentioned above and, as a result, has found the following problems. Namely, the technique disclosed in the above-mentioned Emori literature requires two semiconductor laser light sources and a polarization beam combiner, whereby a light source unit equipped therewith becomes greater in size and expensive.

On the other hand, the invention disclosed in the above-mentioned Japanese Patent Application Laid-Open No. 2001-147454 necessitates a long polarization-maintaining optical fiber which may have a length of several meters depending on the wavelength bandwidth of light outputted from the light source. For example, in order for the Raman amplification gain to have a polarization dependence of 0.2 dB or less when the Raman amplification gain is 25 dB with reference to a signal light power without Raman amplification, the degree of polarization of pumping light is required to be 3% or less in the case where pumping light propagating in the same direction as the signal propagation direction is supplied. When the wavelength bandwidth of light outputted from the light source is about 1 nm, the length of the polarization-maintaining optical fiber required for making the pumping light attain a degree of polarization of 3% or less is about 8 m. Since a long polarization-maintaining optical fiber having a length of several meters is necessary as such, the light source unit equipped therewith also increases its size.

While the foregoing explanation of conventional techniques relates to depolarization of Raman amplification pumping light, there are also cases where light propagating through an optical fiber is preferably in a nonpolarized state.

For overcoming the problems mentioned above, it is an object of the present invention to provide a small-size, inexpensive grating device which can lower the degree of polarization of light, a light source unit including the grating device, and an optical system including the light source unit.

The present invention provides a grating device comprising an optical waveguide for propagating two modes having respective polarization directions different from each other, and a long-period grating disposed within the optical waveguide so as to extend longitudinally of the optical waveguide. The long-period grating carries out a conversion between first and second mode light components having respective polarization directions orthogonal to each other. When the first mode light component is fed into the grating device according to the present invention, a part of the first mode light component is converted into the second mode light component, whereas the grating device outputs not only the first mode light component but also the second mode light component. This lowers the degree of polarization of light fed into the grating device. The degree of polarization of light outputted from the grating device is lowered in particular when the mode conversion ratio between the first and second mode light components is 50%±10%. The optical waveguide preferably includes a polarization-maintaining optical fiber.

The mode conversion ratio is the ratio between respective powers of the first and second mode light components. Also, in general, the modes of the polarization-maintaining optical fiber are so-called “fast mode” and “slow mode”, respectively.

As shown in U.S. Pat. No. 5,703,978, the long-period grating is a grating inducing the coupling (mode coupling) between the core mode and cladding mode propagating through an optical fiber, and thus is a grating clearly distinguished from a short-period grating (Bragg grating) which reflects light centered at a predetermined wavelength. For attaining a strong power conversion from the core mode to the cladding mode, the grating period (pitch) in a long-period grating is set such that the optical path difference between the core and cladding modes becomes 2π. As a consequence, the long-period grating operates so as to combine the core mode with the cladding mode, whereby the core mode decays over a narrow band centered at a predetermined wavelength (hereinafter referred to as loss wavelength).

The present invention provides a light source unit for outputting light, and a grating device having the structure mentioned above (grating device according to the present invention). In the grating device, an optical waveguide for propagating the light outputted from the light source is provided with a long-period grating. The light source preferably includes a semiconductor laser light source. The light outputted from the semiconductor laser light source has a predetermined polarization direction and passes through the grating device, whereby the degree of polarization of light outputted from the light source unit is lowered to 20% or less.

Preferably, in the case where the light source includes a semiconductor laser light source, the light source unit according to the present invention further comprises an optical feedback device. The semiconductor laser light source has a reflecting surface with a higher reflectance and an exit face with a lower reflectance holding an active layer therebetween. The optical feedback device comprises an optical waveguide for propagating laser light from the semiconductor laser light source, and a Bragg grating disposed within the optical waveguide so as to extend longitudinally of the optical waveguide. The Bragg grating is a short-period grating which partly reflects, of the light outputted from the exit face of the semiconductor laser light source, a light component within a specific wavelength region, thereby making the reflected light component enter the active layer by way of the exit face of the semiconductor laser light source. The rest of light component within the specific wavelength region is transmitted through the Bragg grating, so as to be led to the grating device. In the light source unit, the reflecting surface of the semiconductor laser light source and the optical feedback device constitute a Fabry-Perot resonator, whereby light within the reflection band of the optical feedback device is outputted from the optical feedback device. The light outputted from the light source unit not only lowers its degree of polarization, but also stabilizes its wavelength and power since the optical feedback device is provided as such. Preferably, the long-period grating and the Bragg grating are provided in a common optical waveguide (unitary optical waveguide), whereby the light source unit can be made smaller.

The present invention provides an optical system comprising a light source unit having the structure mentioned above (light source unit according to the present invention), and an optical fiber transmission line for propagating light outputted from the light source unit. Preferably, the light source unit outputs light inducing a nonlinear optical phenomenon, e.g., stimulated Raman scattering, four-wave mixing, or the like, in the optical fiber. In the optical system, the light having a low degree of polarization outputted from the light source unit propagates through the optical fiber transmission line. As a consequence, its polarization dependence decreases, thus enabling stable system operations.

The present invention will be more fully understood from the detailed description given hereinbelow and the accompanying drawings, which are given by way of illustration only and are not to be considered as limiting the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will be apparent to those skilled in the art from this detailed description.

### BRIEF DESCRIPTION OF THE DRAWINGS

FIG. 1 is a diagram showing a structure of a light source unit according to the present invention;

FIG. 2A is a sectional view of a polarization-maintaining optical fiber, whereas FIGS. 2B and 2C are refractive index profiles showing refractive indices of individual parts on lines L1 and L2 in FIG. 2A, respectively;

FIG. 3 is a diagram showing a cross-sectional structure of a grating device according to the present invention;

FIG. 4 is a diagram showing a structure of a first embodiment of the optical system according to the present invention; and

FIG. 5 is a diagram showing a structure of a second embodiment of the optical system according to the present invention.

### DETAILED DESCRIPTION OF THE PREFERRED EMBODIMENTS

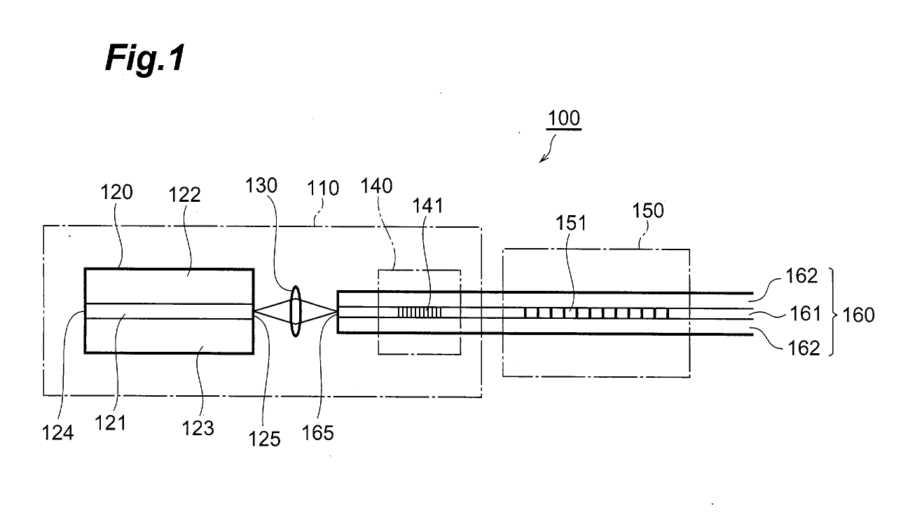

In the following, embodiments of the grating device, light source unit, and optical system according to the present invention will be explained in detail with reference to FIGS. 1, 2A to 2C, and 3 to 5. In the explanation of the drawings, constituents identical to each other will be referred to with numerals identical to each other without repeating their overlapping descriptions.

FIG. 1 is a diagram showing a structure of a light source unit 100 according to the present invention. This diagram shows a cross section of the light source unit 100, taken along a plane including the optical axis. The light source unit 100 comprises a resonator unit 110, and a grating device 150 including a long-period grating. The resonator unit 110 includes a semiconductor laser light source 120, a lens 130, and an optical feedback device 140.

The semiconductor laser light source 120 has an active layer 121 sandwiched between cladding layers 122 and 123, and a reflecting surface 124 and an exit face 125 which hold the active layer 121 therebetween. The reflecting surface 124 is coated with a dielectric multilayer film and exhibits a higher reflectance. The exit face 125 is provided with an antireflection coating and exhibits a lower reflectance. Through the exit face 125, light is transmitted between the active layer 121 and the outside with a high efficiency.

The optical feedback device 140 comprises a polarization-maintaining optical fiber 160 which is an optical waveguide for propagating two modes having respective polarization directions different from each other, and a Bragg grating 141 disposed within the polarization-maintaining optical fiber 160 so as to extend longitudinally of the polarization-maintaining optical fiber 160. The light outputted from the exit face 125 of the semiconductor laser light source 120 is taken into the optical feedback device 140 from an end face 165 of the polarization-maintaining optical fiber 160, whereas a part of the light component within a specific wavelength region in the incident light is reflected by the Bragg grating 141. The reflected light is emitted from the end face 165 toward the semiconductor laser light source 120, and reaches the inside of the active layer 121 by way of the exit face 125 of the semiconductor laser light source 120. Toward the grating device 150, the optical feedback device 140 outputs the rest of light transmitted through the Bragg grating 141.

The lens 130 is disposed between the exit face 125 of the semiconductor laser light source 120 and the end face 165 of the polarization-maintaining optical fiber 160. The lens 130 converges the light outputted from the exit face 125 of the semiconductor laser light source 120 and leads thus converged light to the end face 165 of the polarization-maintaining optical fiber 160. Also, the lens 130 converges the light outputted from the end face 165 of the polarization-maintaining optical fiber 160 and leads thus converged light to the exit face 125 of the semiconductor laser light source 120.

The grating device 150 comprises the polarization-maintaining optical fiber 160, which is an optical waveguide, and a long-period grating 151 disposed within the polarization-maintaining optical fiber 160 so as to extend longitudinally of the polarization-maintaining optical fiber 160. The long-period grating 151 in the grating device 150 has such a grating period that first and second mode light components propagating through the polarization-maintaining optical fiber 160 in the same direction while having respective polarization directions orthogonal to each other satisfy a phase matching condition therebetween.

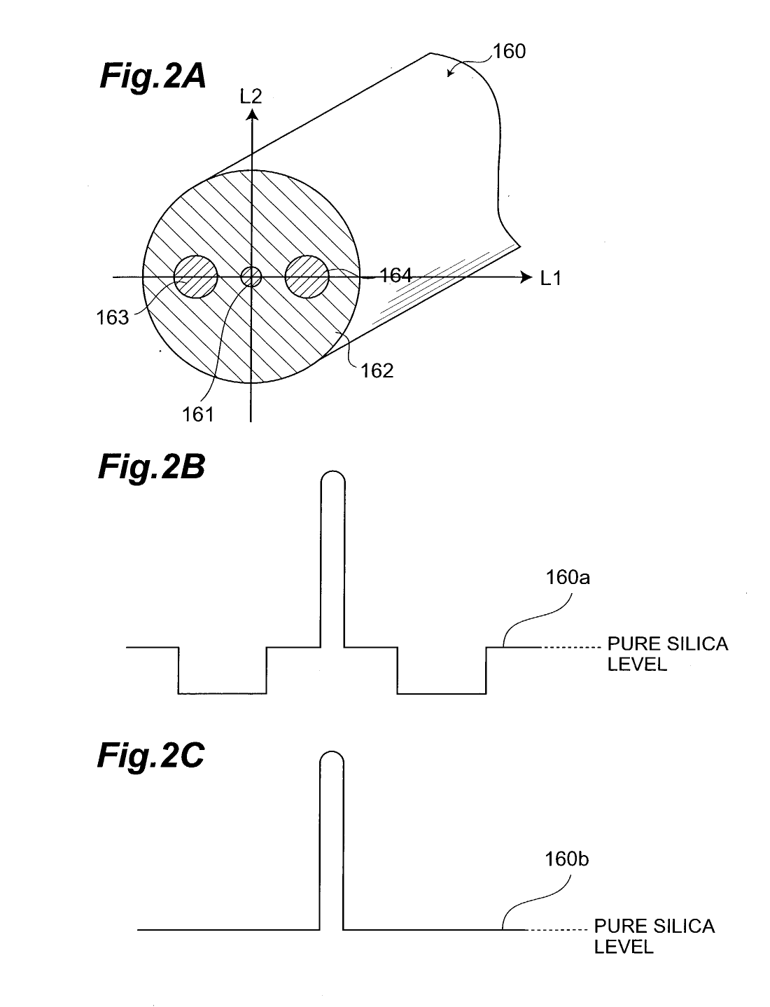

FIG. 2A is a sectional view of the polarization-maintaining optical fiber 160. This sectional view shows the cross section of the polarization-maintaining optical fiber 160 taken along a plane orthogonal to the optical axis. The polarization-maintaining optical fiber 160 comprises a core region 161 with a higher refractive index containing the optical axis center, a cladding region 162 with a lower refractive index surrounding the core region 161, and a pair of stress-applying regions 163, 164 disposed within the cladding region 162 so as to hold the core region 161 therebetween. While the polarization-maintaining optical fiber 160 employs silica glass as its host material, the core region 161 is doped with GeO₂, and each of the stress-applying regions 163, 164 is doped with B₂O₃. FIG. 2B shows a refractive index 160a along line L1 in FIG. 2A, whereas FIG. 2C shows a refractive index profile 160b along line L2 in FIG. 2A.

In such a polarization-maintaining optical fiber 160, a tension will remain in the direction connecting the stress applying regions 163 and 164 to each other if the optical fiber preform is heated, drawn, and cooled in succession. Therefore, in the light propagating through the polarization-maintaining optical fiber 160, the effective refractive index of the first mode light component having the polarization direction oriented in the direction connecting the stress applying regions 163 and 164 to each other differs from that of the second mode light component having a polarization direction oriented in a direction orthogonal thereto, whereby their propagation constants differ from each other as well. As a consequence, each of the first and second mode light components propagating through the polarization-maintaining optical fiber 160 can propagate while keeping its polarization direction.

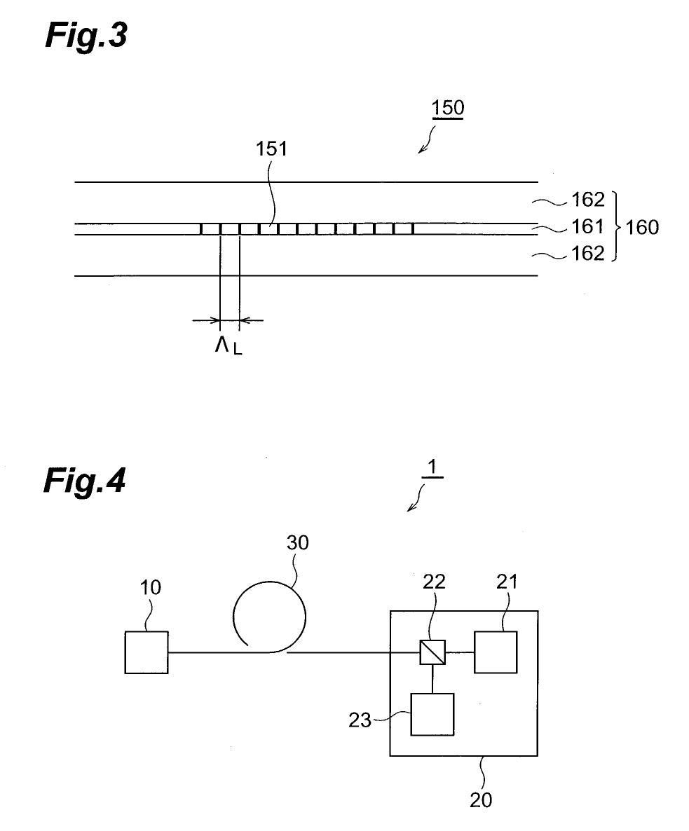

FIG. 3 is a sectional view showing the structure of the grating device 150 according to the present invention. This drawing shows a cross section of the grating device 150 taken along a plane including the optical axis. In the grating device 150, the long-period grating 151 is disposed so as to extend longitudinally of the core region 161 of the polarization-maintaining optical fiber 160. Such a long-period grating 151 is obtained when a position to raise its refractive index in the core region 161 is irradiated with ultraviolet light (e.g., ultraviolet laser light having a wavelength of 248 nm outputted from a KrF excimer laser light source).

Letting Λ_{L} be the grating period of the long-period grating 151, N₁ be the effective refractive index with respect to the first mode light component, N₂ be the effective refractive index with respect to the second mode light component, and λ be the wavelength of each of the first and second mode light components, the phase matching condition represented by the following expression (1):

(2π/λ(N₂−N₁)=2π/Λ_{L} (1)

holds.

From the above-mentioned expression (1), the grating period Λ_{L} of the long-period grating 151 is represented by the following expression (2):

Λ_{L}=λ/(N₂−N₁) (2)

where N₂−N₁ is the birefringence of the polarization-maintaining optical fiber 160.

The grating device 150 formed with the long-period grating 151 satisfying such a phase matching condition can carry out a mode conversion between the first and second mode light components propagating through the polarization-maintaining optical fiber 160. For example, the first mode light component propagating through the polarization-maintaining optical fiber 160 is partly converted into the second mode light component in the long-period grating 151, whereby the long-period grating 151 outputs not only the first mode light component but also the second mode light component. On the other hand, the second mode light component propagating through the polarization-maintaining optical fiber 160 is partly converted into the second mode light component in the long-period grating 151, whereby the long-period grating 151 outputs not only the second mode light component but also the first mode light component. Here, the mode conversion ratio between the first and second mode light components in the long-period grating 151 is preferably 50%±10%. In this case, the grating device 150 can effectively reduce the degree of polarization of incident light.

On the other hand, the optical feedback device 140 comprises the polarization-maintaining optical fiber 160 and the Bragg grating 141 disposed within the core region 161 of the polarization-maintaining optical fiber 160 so as to extend longitudinally of the core region 161. The Bragg grating 141 selectively reflects a part of light having a wavelength λ represented by the Bragg condition of the following expression (3):

λ=2NΛ_{B} (3)

where Λ_{B} is the grating period of the Bragg grating 141, and N is its effective refractive index.

In the Bragg grating 141 of the optical feedback device 140, the grating period Λ_{B} continuously changes in the longitudinal direction, whereas its reflection bandwidth is several nanometers.

Here, the reflecting surface 124 of the semiconductor laser light source 120 and the optical feedback device 140 constitute a Fabry-Perot resonator (resonator unit 110; see FIG. 1). In the light generated in the active layer 121 of the semiconductor laser light source 120, the light component within the reflection band of the optical feedback device 140 travels back and forth within the resonator unit 110, thereby generating stimulated emission in the active layer 112. Then, a part of the light within the resonator unit 110 passes through the optical feedback device 140, so as to be outputted from the resonator unit 110.

The output light from the resonator unit 110 has a polarization direction parallel to the junction surfaces between the active layer 112 and cladding layers 122, 123 of the semiconductor laser light source 120, and propagates through the polarization-maintaining optical fiber 160 while keeping its polarization state, thereby reaching the grating device 150. Here, depending on the angle formed between the direction connecting the stress-applying regions 163 and 164 to each other and the above-mentioned junction surfaces, the power ratio between the first and second mode light components entering the grating device 150 varies. For example, only the first mode light component will enter the grating device 150 if the above-mentioned angle is 0 degree. Only the second mode light component will enter the grating device 150 if the above-mentioned angle is 90 degrees. The first and second mode light components will enter the grating device 150 with equal powers if the above-mentioned angle is 45 degrees.

When the output light from the resonator unit 110 enters the grating device 150, its degree of polarization is lowered by the grating device 150. For example, when the first mode light component enters the grating device 150, it is partly converted into the second mode light component by the grating device 150, whereby the grating device 150 outputs not only the first mode light component but also the second mode light component. When the second mode light component enters the grating device 150, it is partly converted into the first mode light component by the grating device 150, whereby the grating device 150 outputs not only the second mode light component but also the first mode light component. When both the first and second mode light components enter the grating device 150, the first mode light component is partly converted into the second mode light component by the grating device 150, whereas the second mode light component is partly converted into the first mode light component by the grating device 150, whereby the grating device 150 outputs both the first and second mode light components.

Thus, even when light outputted from the resonator unit 110 has a predetermined polarization direction, the light outputted from the light source unit 100 lowers its degree of polarization. In particular, the degree of polarization of light outputted from the light source unit 100 is sufficiently low when the mode conversion ratio between the first and second mode light components in the long-period grating 151 is about 50%.

The grating device 150 according to the present invention is small in size and inexpensive, since it comprises the polarization-maintaining optical fiber 160 and the long-period grating 151 formed in the polarization-maintaining optical fiber 160. Also, the light source unit 100 according to the present invention is small in size and inexpensive, since it includes such a grating device 150 and one resonator unit 110. The light source unit 100 is also small in that the Bragg grating 141 of the optical feedback device 140 and the long-period grating 151 of the grating device 150 are formed in the common polarization-maintaining optical fiber 160.

FIG. 4 is a diagram showing a structure of a first embodiment of the optical system according to the present invention. The optical system 1 shown in this diagram comprises an optical transmitter 10, an optical receiver 20, and an optical fiber 30 laid between the optical transmitter 10 and optical receiver 20. A light-receiving section 21, an optical coupler 22, and a pumping light source unit 23 are disposed within the optical receiver 20. The optical system 1 supplies the optical fiber 30 with the pumping light outputted from the pumping light source unit 23, thereby inducing a nonlinear optical phenomenon in the optical fiber 30. In the following, stimulated Raman scattering will be explained as a nonlinear optical phenomenon. The pumping light source unit 23 has a configuration similar to that of the light source unit 100.

The optical transmitter 10 sends one or a plurality of channels of signal light having wavelengths different from each other to the optical fiber 30, whereas the optical receiver 20 inputs the signal light transmitted through the optical fiber 30. The pumping light source unit 23 within the optical receiver 20 outputs one or a plurality of channels of pumping light having wavelengths different from each other. The optical coupler 22 outputs to the optical fiber 30 the pumping light outputted from the pumping light source unit 23, and outputs to the light-receiving section 21 the signal light arriving after having propagated through the optical fiber 30. The light-receiving section 21 receives the signal light having arrived from the optical coupler 22. For example, the optical fiber 30 employs silica glass as a host material, whereas its signal wavelength lies in the band of 1.55 μm. In this case, the pumping light wavelength is about 1.45 μm, which is shorter than the signal light wavelength by about 100 nm.

The signal light sent from the optical transmitter 10 propagates through the optical fiber 30, thereby reaching the optical receiver 20. While propagating through the optical fiber 30, the signal light decays due to the transmission loss inherent in the optical fiber 30, but is Raman-amplified by the pumping light supplied from the pumping light source unit 23. Therefore, the optical system 1 can elongate the transmission distance between the optical transmitter 10 and the optical receiver 20.

In particular, since the optical system 1 according to the first embodiment employs the pumping light source unit 23 having a configuration similar to that of the light source unit 100, the degree of polarization of pumping light supplied to the optical fiber 30 is low. Therefore, the polarization dependence of Raman amplification gain in signal light in the optical fiber 30 is lowered. As a consequence, even when the polarization direction of signal light fluctuates with time, the fluctuation in Raman amplification gain in synchronization with the temporal fluctuation in the polarization direction is small. Hence, the optical system 1 can attain a stable transmission quality.

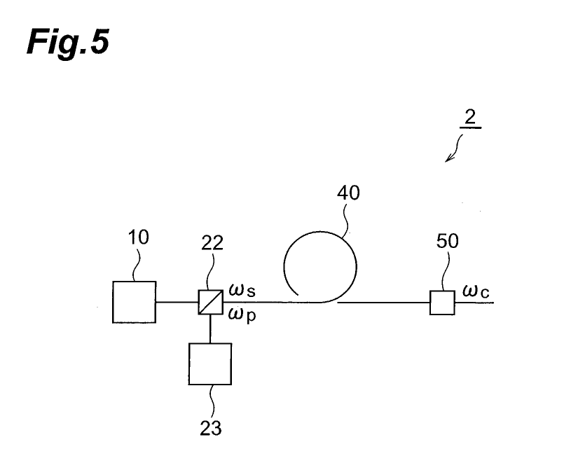

FIG. 5 is a diagram showing a configuration of a second embodiment of the optical system according to the present invention. The optical system 2 shown in this diagram comprises an optical transmitter 10, an optical coupler 22, a pumping light source unit 23, a highly nonlinear optical fiber 40, and an optical filter 50. In the optical system 2, signal light (at frequency ωₛ) outputted from the optical transmitter 10 and pumping light (at frequency ωₚ) supplied from the pumping light source unit 23 are combined together by the optical coupler 22, so as to be sent to the optical fiber 40. This induces a nonlinear optical phenomenon in the optical fiber 40, whereby signal light having a new wavelength (at frequency ω_{c}) is transmitted through the optical filter 50. The pumping light source unit 23 has a configuration similar to that of the light source unit 100.

In the case where the signal light (at frequency ωₛ) outputted from the optical transmitter 10 and the pumping light (at frequency ωₚ) supplied from the pumping light source unit 23 have respective frequencies closer to each other in the vicinity of the zero-dispersion wavelength of the optical fiber 40, four-wave mixing, which is a kind of nonlinear optical phenomena, occurs in the optical fiber 40. The frequency ω_{c} of the signal light occurring due to four-wave mixing is represented by the expression of ω_{c}=2ωₚ−ωₛ. The signal light at the new frequency ω_{c} carries the same information as with the initial signal light at the new frequency ωₛ. Only the signal light at the new frequency ω_{c} is transmitted through the optical filter 50, so as to be outputted. Namely, the optical system 2 converts the frequency of signal light to another.

The degree of polarization in pumping light supplied to the optical fiber 40 is low in the optical system 2 according to the second embodiment in particular, since it employs the pumping light source unit 23 having a configuration similar to that of the light source unit 100. Therefore, the polarization dependence of signal light wavelength conversion in signal light in the optical fiber 40 is lowered. As a consequence, even when the polarization direction of signal light fluctuates with time, the fluctuation in signal light wavelength conversion efficiency in synchronization with the temporal fluctuation in the polarization direction is small.

Without being restricted to the above-mentioned embodiments, the present invention can be modified in various manners. For example, the grating device 150 may employ a planar substrate having a waveguide region formed with a long-period grating instead of the polarization-maintaining optical fiber 160 formed with a long-period grating. In this case, the grating period is determined such that TE and TM mode light components satisfy a phase matching condition in the long-period grating.

The optical feedback device 140 may be omitted. However, the case provided with the optical feedback device 140 is preferred in that the wavelength and power of output light can be stabilized. The light entering the grating device 150 may be supplied not only from the semiconductor laser light source 120 but also from other light sources.

Though the optical system 1 according to the first embodiment has a (backward pumping) structure in which the pumping light is supplied so as to propagate in the direction opposite from the signal light propagating direction, it may have a (forward pumping) structure in which the pumping light propagates in the signal light propagating direction. Though the optical systems 1, 2 according to the first and second embodiments utilize stimulated Raman scattering or four-wave mixing, other nonlinear optical phenomena can be utilized as well.

The light source unit 100 according to the present invention can be used as a transmitter, so as to prevent the transmission quality of signal light from fluctuating with time due to polarization mode dispersion.

In the present invention, as explained in the foregoing, a long-period grating is disposed within an optical waveguide for propagating two modes having respective polarization directions different from each other, so as to extend longitudinally of the optical waveguide, whereby first and second mode light components having respective polarization directions orthogonal to each other are mode-converted therebetween in the long-period grating. While the light incident on the grating device lowers its degree of polarization, the grating device becomes smaller in size and inexpensive.

The light source unit according to the present invention comprises a light source for outputting light, and the grating device in which a polarization-maintaining optical fiber for propagating light outputted from the light source is formed with a long-period grating. Even when the light outputted from the light source has a specific polarization direction, it passes through the grating device in the light source unit, whereby the light outputted from the light source unit lowers its degree of polarization. This light source unit can also be made smaller in size and inexpensive.

The optical system according to the present invention comprises the above-mentioned light source unit, and an optical fiber for propagating light outputted from the light source unit. In this optical system, the light having a low degree of polarization outputted from the light source unit propagates through the optical fiber. This lowers the polarization dependence, thus enabling stable system operations.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A grating device comprising:
an optical waveguide for propagating two modes having respective polarization directions different from each other; and
a long-period grating disposed within said optical waveguide so as to extend longitudinally of said optical waveguide, said long-period grating being adapted to carry out a mode conversion between first and second mode light components having respective polarization directions orthogonal to each other.

2. A grating device according to claim 1, wherein said long-period grating has a mode conversion ratio of 50%±10% between said first and second mode light components.

3. A grating device according to claim 1, wherein said optical waveguide includes a polarization-maintaining optical fiber.

4. A light source unit comprising:
a light source for outputting light; and
a grating device according to claim 1, said light outputted from said light source propagating through said grating device.

5. A light source unit according to claim 4, wherein said light source includes a semiconductor laser light source.

6. A light source unit according to claim 4, wherein said light source includes a semiconductor laser light source having a reflecting surface with a higher reflectance and an exit face with a lower reflectance holding an active layer therebetween;
said light source unit further comprising an optical feedback device, said optical feedback device having:
an optical waveguide for propagating light outputted from said exit face of said semiconductor laser light source; and
a Bragg grating disposed within said optical waveguide so as to extend longitudinally of said optical waveguide; said Bragg grating partly reflecting, of light inputted from an end face of said optical waveguide, a light component within a specific wavelength region so as to make thus reflected light component enter said active layer by way of said exit face of said semiconductor laser light source, while transmitting the rest of light component in said specific wavelength region through said Bragg grating toward said grating device.

7. A light source unit according to claim 6, wherein said grating device and said optical feedback device include a common optical waveguide and are constructed by forming said long-period grating and said Bragg grating within said common optical waveguide.

8. An optical system comprising:
a light source unit according to claim 4; and
an optical fiber for propagating light outputted from said light source unit.

9. An optical system according to claim 8, wherein said light source unit outputs light for inducing a nonlinear optical phenomenon in said optical fiber.

10. An optical system according to claim 9, wherein said nonlinear optical phenomenon includes stimulated Raman scattering.

11. An optical system according to claim 9, wherein said nonlinear optical phenomenon includes four-wave mixing.

12. A grating device comprising:
a polarization-maintaining optical fiber having a core region extending along a predetermined axis, a cladding region provided on an outer periphery of said core region, and a stress-applying region provided within at least said cladding region while extending along said core region; and
a long-period grating disposed within said core region of said polarization-maintaining optical fiber.

13. A light source unit comprising:
a light source for outputting one or a plurality of channels of light having respective wavelengths different from each other; and
a grating device according to-claim 12 provided at a position where said light outputted from said light source reaches.

14. A light source unit according to claim 13, further comprising:
a Bragg grating for partly reflecting, of said light outputted from said light source, a light component having a specific wavelength, said Bragg grating being disposed between said light source and said long-period grating within said core region in said polarization-maintaining optical fiber of said grating device.

15. A light source unit according to claim 13, further comprising:
a lens disposed between said light source and said grating device.

16. An optical system comprising:
an optical fiber transmission line for propagating a plurality of channels of signal light having respective wavelengths different from each other; and
a light source unit according to claim 13.
